(19) United States
(12) Patent Application Publication
(10) Pub. No.: US 2016/0283987 A1
(43) Pub. Date: Sep. 29, 2016

(54) TRIPLE AUCTION

(71) Applicant: Shinji NISHIMURA, Yokohama-shi (JP)

(72) Inventor: Shinji NISHIMURA, Yokohama-shi (JP)

(21) Appl. No.: 15/019,970

(22) Filed: Feb. 10, 2016

Related U.S. Application Data
(63) Continuation of application No. PCT/JP2015/059306, filed on Mar. 26, 2015.

(51) Int. Cl. G06Q 30/02; G06Q 30/06; G06Q 30/08

(52) U.S. Cl. CPC G06Q 30/0278; G06Q 30/08; G06Q 30/0609

(57) ABSTRACT

A plurality of internet auctions, which are transacted independently for a transaction partner and independently for a transaction object, are combined to improve reliability of a transaction, correctness of an appraisement of a commodity and a guarantee of the commodity and achieve a fair and safe internet auction. An internet auction of the commodity, a guarantee charge internet auction and a reverse internet auction of a guaranteed written opinion are combined in one transaction, although they are originally done independently for a transaction partner and independently for a transaction object, by letting a plurality of third parties who are neutral be participated in the transaction between a seller of the commodity and a buyer. Thus, the seller of the commodity and the buyer can fairly and safely transaction the commodity on the internet auction.

### CROSS-REFERENCES TO RELATED APPLICATIONS

This Application claims the benefit of priority and is a Continuation application of the prior International Patent Application No. PCT/JP2015/059306, with an international filing date of Mar. 26, 2015, which designated the United States, the entire disclosures of all applications are expressly incorporated by reference in their entirety herein.

### BACKGROUND OF THE INVENTION

1. Field of the Invention

The present invention relates to a business model of combining, in one transaction, a plurality of individual internet auctions such as an internet auction of commodity, an internet auction of guarantee charges and a reverse internet auction of guaranteed written opinions by using an information processing device and an internet communication so as to ensure fair price formation and secure transaction.

Note that the information processing device is a general term for devices such as a computer, a server, a tablet terminal, a mobile phone and a smartphone having both information processing function and internet communication processing function.

2. Description of Related Art

In the conventional internet auction, using the information processing device and the internet communication, a buyer who wants a transaction participates in a bidding by referring to commodity information unilaterally provided by a service provider managing the internet auction.

Patent document 1: Japanese Unexamined Patent Application Publication No. 2013-134514

### BRIEF SUMMARY OF THE INVENTION

Various kinds of commodities are transacted in the internet auction. In addition, prices of the commodities vary widely from low to high price. When an expensive commodity is transacted, in particular, fair transaction, secure transaction, accurate evaluation of the commodity, and guarantee of the commodity should be strongly required.

However, in the conventional internet auction, the commodities are transacted by referring inconsistent commodity information provided by an exhibitor as a seller, mechanically determined evaluation provided by a service provider of the internet auction, or evaluation not connected to the commodity. Even if a written opinion is attached to the commodity, there is a possibility that the written opinion itself cannot be trusted. Thus, the system of the conventional internet auction cannot be strongly trusted when dealing with an expensive commodity.

As a result, there is a risk that a fake product is distributed without any hesitation and bought at a high price, or a valuable thing is bought at a low price.

An exhibitor as a seller worries about the internet auction since the seller does not have enough knowledge about a reasonable market price of the commodity to be exhibited and does not have correct and enough information about the commodity. In such a case, the seller may doubt about the fair price formation and give up the exhibition.

A bidder as a buyer worries about the internet auction since credibility of the exhibited commodity and necessary information about the commodity are not enough for the buyer. In such a case, the buyer may consider the risk of the transaction not accompanied with a guarantee and give up to participate in a bidding.

In the present invention, a third party who is a neutral participant not belonging to neither the exhibitor as a seller nor the bidder as a buyer is participated in the transaction. The third party considers the standpoint of both the exhibitor as a seller and the bidder as a buyer, prevents the price from becoming unfair, and eliminates malicious commodity to ensure a fair price formation in the transaction.

In addition to the conventional internet auction where an exhibitor as a seller and a bidder as a buyer trade the commodity, a third party who is a neutral participant not belonging to neither the seller nor the buyer is participated in a field of appraise and guarantee of the commodity using a method of the internet auction. Since the guaranteed written opinion having high credibility is attached to the commodity, a valuable high quality product and a genuine product are prevented from being bought at an extremely low price or a worthless low range product and a fake product are prevented from being bought at an extremely high price.

The present invention provides a business model to enable both the exhibitor as a seller and the bidder as a buyer to achieve secure and transparent transaction.

A plurality of internet auctions, which are transacted independently for a transaction partner and independently for a transaction object, is combined in one transaction on a website of a service provider managing an internet auction (hereafter, referred to as a service provider) by using an information processing device and an internet communication. The combined internet auctions are such as an internet auction for trading a commodity between an exhibitor as a seller (hereafter, referred to as a seller) and a bidder as a buyer (hereafter, referred to as a buyer) on the website of the service provider managing the internet auction by using the information processing device and the internet communication, a guarantee charge internet auction joined by a plurality of guarantors for determining a particular guarantor and a guarantee charge on the website of the service provider managing the internet auction by using the information processing device and the internet communication by disclosing a plurality of written opinions of the commodity provided by a plurality of appraisers to a plurality of guarantors to determine the particular guarantor and the guarantee charge so that each of the written opinions is guaranteed, and a reverse internet auction of the guaranteed written opinions to let the seller of the commodity select a particular guaranteed written opinion from the guaranteed written opinions provided and guaranteed by the appraisers and the guarantors on the website of the service provider managing the internet auction by using the information processing device and the internet communication.

The information processing device is a general term for a device such as a computer, a server, a tablet terminal, a mobile phone and a smartphone having both information processing function and internet communication processing function.

As shown in FIG. 1, a service provider, a seller, an appraisement group in which a plurality of appraisers are joined, an insurance group in which a plurality of guarantors are joined, and a buyer are participated in one transaction in accordance with respective roles on the website of the service provider managing the internet auction by using the information processing device and the internet communication.

The service provider makes a contract with each of the plurality of appraisers and the plurality of guarantors, and manages the internet auction on the website by using the information processing device and the internet communication to look for the seller of the commodity.

The service provider asks the seller to provide the images of the commodity and the commodity information to be exhibited on the website of the internet auction by using the information processing device and the internet communication.

In case it is difficult to appraise the commodity from the images, the service provider asks the seller to send the commodity itself to a facility designated by the service provider.

In addition, the service provider receives a commission fee from the seller.

The service provider discloses the images of the commodity and the commodity information to the appraisement group on the website of the internet auction by using the information processing device and the internet communication. In case it is difficult to appraise the commodity from the images, the seller discloses the commodity itself at a facility where the appraisement group can appraise the commodity.

Each of the appraisers joined in the appraisement group independently prepares a written opinion and sends information of the written opinion to the website of the service provider managing the internet auction by using the information processing device and the internet communication.

As shown in FIG. 2, the service provider discloses all of the information of the written opinions of the commodity to the insurance group on the website of the service provider managing the internet auction by using the information processing device and the internet communication and provides a guarantee charge internet auction to determine the particular guarantor and the guarantee charge of each of the written opinions.

Each of the guarantors joined in the insurance group analyzes and checks each of the written opinions and sends a bid price, which is called as a guarantee charge, to the website of the service provider managing the internet auction by using the information processing device and the internet communication.

The guarantor who bid the lowest price wins the auction. Thus, the won guarantor and the guarantee charge proposed by the guarantor are determined and connected with each of the written opinions to serve as a guaranteed written opinion.

As shown in FIG. 3, the service provider provides a reverse internet auction of the guaranteed written opinions by disclosing to the seller a plurality of guaranteed written opinions appraised and guaranteed by a plurality of appraisers and a plurality of guarantors on the website of internet auction by using the information processing device and the internet communication.

The seller selects a particular (desirable) guaranteed written opinion from the disclosed guaranteed written opinions and sends a selection result to the website of the service provider managing the internet auction by using the information processing device and the internet communication.

For providing the internet auction of the commodity, the service provider discloses the images of the exhibited commodity and the guaranteed written opinion selected by the seller on the website of the service provider managing the internet auction by using the information processing device and the internet communication to look for the buyer.

With reference to the images of the commodity and the guaranteed written opinion, the buyer sends a bid price to the website of the service provider managing the internet auction by using the information processing device and the internet communication.

The buyer who bid the highest price wins the auction and the internet auction is finished.

By using the present invention, a particular participant is not put in an advantageous condition in the transaction. Thus, both the seller and the buyer are treated fairly and not biased to either side. Therefore, a fake product and a worthless product are prevented from being transacted at an extremely high price, and a valuable product is prevented from being transacted at an extremely low price. Thus, the participant can join the internet auction without anxiety.

The service provider can fairly and safely manage the transaction of the internet auction.

The above described and other purposes, features and advantages of the present invention will become apparent from the following explanations related with the attached drawings showing the preferred embodiment of the present invention.

### BRIEF DESCRIPTION OF THE DRAWINGS

FIG. 1 shows a system configuration of the present embodiment.

FIG. 2 shows a configuration of a guarantee charge internet auction of the present embodiment.

FIG. 3 shows a configuration of a reverse internet auction of guaranteed written opinions of the present embodiment.

FIG. 4 shows a hardware configuration of an information processing device of the present embodiment.

### DETAILED DESCRIPTION OF THE INVENTION

Hereafter, the method of the internet auction of the present embodiment will be explained with reference to the drawings.

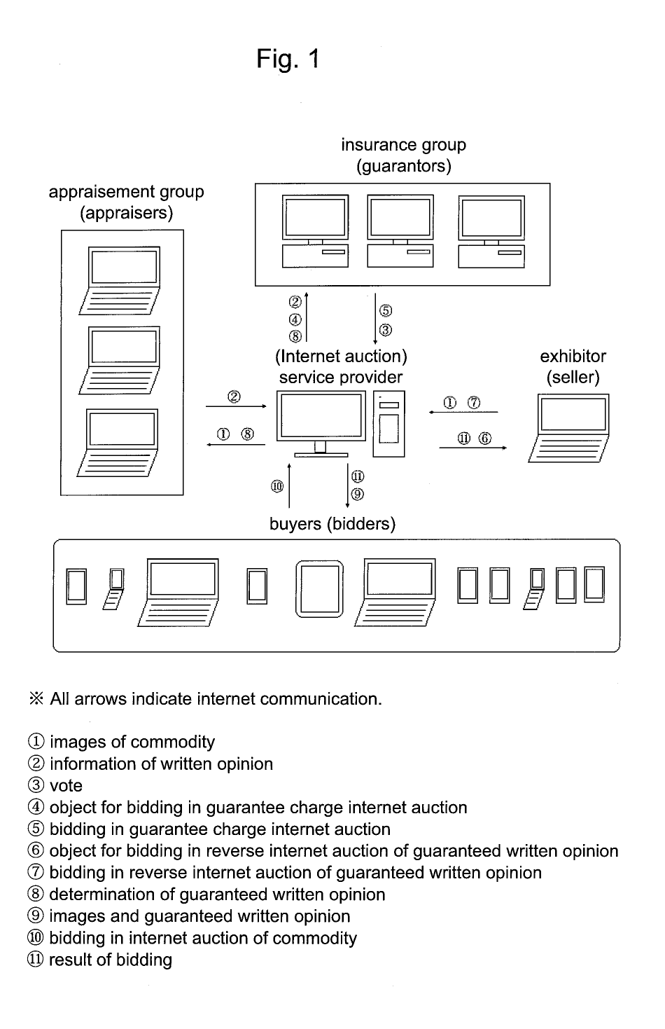

FIG. 1 shows a system configuration of the present embodiment.

A triple auction is a business model for further enhancing the reliability of the conventional internet auction of the commodity to realize a fair and safe transaction and not cause anxiety for the participant.

In order to achieve the above purpose, a plurality of internet auctions, which are transacted independently for a transaction partner and independently for a transaction object, are combined in one transaction. For example, the internet auction of the commodity is combined with the guarantee charge internet auction and the reverse internet auction of the guaranteed written opinions on the website of the service provider managing the internet auction by using the information processing device and the internet communication. Thus, a particular participant is not put in an advantageous condition in the transaction.

If the written opinion of the specific appraiser is forced to the seller, the appraiser becomes advantageous. If the specific guarantor freely determines the guarantee charge, the guarantor becomes advantageous. If highly evaluated written opinion can be made and used without limitation, the seller of the commodity becomes advantageous. If the commodity information is not reliable and no guarantee is given to the transaction, the buyer becomes disadvantageous. The above described situations can be avoided if the service provider managing the internet auction combines three internet auctions in one transaction on the website by using the information processing device and the internet communication.

The information processing device is a general term for a device such as a computer, a server, a tablet terminal, a mobile phone and a smartphone having both information processing function and internet communication processing function.

A plurality of internet auctions, which are transacted independently for a transaction partner and independently for a transaction object, is combined in one transaction on the website of the service provider managing the internet auction by using the information processing device and the internet communication. The combined internet auctions are such as an internet auction for trading the commodity between the seller and the buyer on the website of the service provider managing the internet auction by using the information processing device and the internet communication, a guarantee charge internet auction joined by a plurality of guarantors on the website of the service provider managing the internet auction by using the information processing device and the internet communication by disclosing a plurality of written opinions of the commodity of the seller provided by a plurality of appraisers to a plurality of guarantors to determine a particular guarantor and a guarantee charge so that each of the written opinions is guaranteed, and a reverse internet auction of the guaranteed written opinions to let the seller of the commodity select the particular guaranteed written opinion from the guaranteed written opinions provided and guaranteed by the appraisers and the guarantors on the website of the service provider managing the internet auction by using the information processing device and the internet communication.

A plurality of internet auctions, which are transacted independently for a transaction partner and independently for a transaction object, such as a guarantee charge internet auction joined by a plurality of guarantors on the website of the service provider managing the internet auction by using the information processing device and the internet communication by disclosing a plurality of written opinions of the commodity of the seller provided by a plurality of appraisers to a plurality of guarantors to determine a particular guarantor and a guarantee charge so that each of the written opinions is guaranteed, and a reverse internet auction of the guaranteed written opinions to let the seller of the commodity select the particular guaranteed written opinion from the guaranteed written opinions provided and guaranteed by the appraisers and the guarantors on the website of the service provider managing the internet auction by using the information processing device and the internet communication are combined with an internet auction for trading the commodity between the seller and the buyer on the website of the service provider managing the internet auction by using the information processing device and the internet communication to let a plurality of third parties who are neutral without belonging to either of the seller and the buyer be participated in the transaction.

The appraisement and the guarantee are done each for the transaction.

The service provider makes a contract with a plurality of appraisers to give a right to participate in the appraisement. The plurality of appraisers are joined in the appraisement group.

The service provider makes a contract with a plurality of guarantors to give a right to participate in the guarantee. The plurality of guarantors are joined in the insurance group.

The service provider looks for the seller of the commodity who wants the transaction, and provides the internet auction joined by the appraisement group and the insurance group on the website of the service provider managing the internet auction by using the information processing device and the internet communication.

The service provider asks the seller who wants the transaction to provide the images of the commodity and the commodity information on the website of the service provider managing the internet auction by using the information processing device and the internet communication. In case it is difficult to appraise the commodity from only the images, the service provider asks the seller to send the commodity itself to a facility prepared by the service provider to enable the appraisement.

The seller pays a commission fee to the service provider.

The service provider discloses the images of the commodity and the commodity information to the appraisement group on the website of the service provider managing the internet auction by using the information processing device and the internet communication.

In case it is difficult to appraise the commodity from the images, the seller discloses the commodity itself at a facility where the appraisement group can appraise the commodity.

The commodity of the seller is appraised by being joined by the plurality of appraisers.

Each of the appraisers in the appraisement group independently appraises the commodity while being conscious of other appraisers. In the appraisement joined by the plurality of appraisers, all appraisers are rivals and competitors. The appraisers cannot provide a one-sided appraisement convenient for himself/herself or the appraisement of poor quality.

The appraisement contains the work of dividing the commodity into three ranks A, B and C then further dividing each of the ranks into three ranks high, middle and low and then displaying the rank, and the work of displaying the upper limit and the lower limit of the predicted price of the commodity.

Each of the appraisers prepares the written opinion and sends the information of the written opinion to the website of the service provider managing the internet auction by using the information processing device and the internet communication.

Unless the written opinion is selected by the seller, the appraiser cannot obtain a commission fee. Because of this, it is predicted that the appraiser overestimates the commodity in the appraisement to make the seller advantageous or the appraiser intentionally makes a false appraisement.

The service provider makes a regulation to maintain the neutrality of the appraisers.

The service provider makes a regulation for expelling the appraiser from the appraisement group when there is a doubt on the appraisement and when return of the commodity occurs or liability for compensating damages arises because of the inadequate appraisement. The appraiser should pay attention to the service provider and the guarantors.

Therefore, the appraiser cannot provide the written opinion advantageous for the seller for the sole purpose of being selected by the seller.

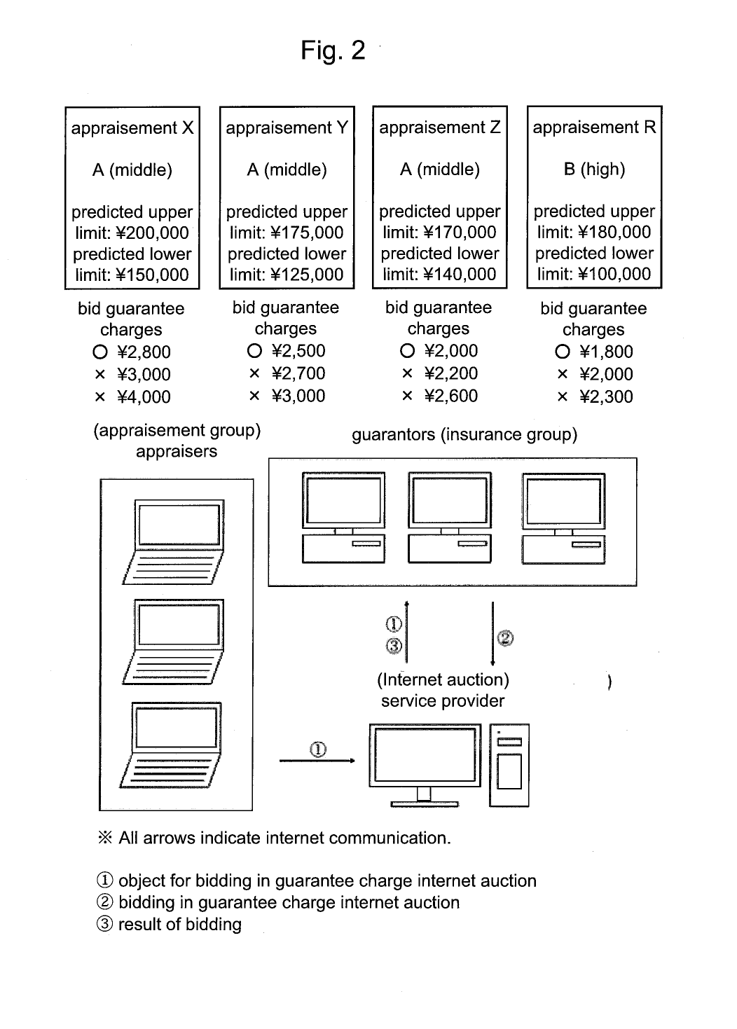

As explained above, a fair appraisement is done each for the transaction. FIG. 2 shows a configuration of a guarantee charge internet auction of the present embodiment.

As shown in FIG. 2, based on the information of the plurality of written opinions sent from the plurality of appraisers to the website of the service provider managing the internet auction using the information processing device and the internet communication, the service provider discloses all the information of the written opinions to the members of the insurance group on the website of the service provider managing the internet auction by using the information processing device and the internet communication to provide the guarantee charge internet auction.

The guarantee charge internet auction is an auction for the guarantors to obtain a right of guaranteeing the written opinion.

The guarantor who bid the lowest guarantee charge wins the auction. Thus, the particular guarantor and the guarantee charge are connected with the written opinion.

The guarantor receives the guarantee charge as a charge of taking on the responsibility for guaranteeing the written opinion.

When return of the commodity occurs or liability for compensating damages arises because of the inadequate written opinion, the guarantor is liable to compensate for damages.

The guarantors in the insurance group should correctly analyze and check the written opinion to avoid the compensation.

Vote is done with the cooperation of the guarantors, and the service provider arbitrarily selects a predetermined percentage of the written opinions to remove the selected written opinions from the transaction.

The above procedure is done to maintain the neutrality of the appraisers.

The service provider managing the internet auction by using the information processing device and the internet communication has all of the guarantors participated in the bidding of the guarantee charge internet auction select an overestimated written opinion and vote for the selected written opinion on the website of the service provider managing internet auction by using the information processing device and the internet communication, and selects arbitrarily a predetermined percentage of the written opinions based on a voting result to remove the selected written opinions from the transaction. Thus, the predetermined percentage of the written opinions is removed from the transaction based on the vote of the bidders.

The above procedure is done to add a check function of the guarantors. This prevents the appraiser from easily overestimating the commodity in the written opinion for the purpose of being selected by the seller. Thus, the above procedure is required to maintain the neutrality of the appraisers.

Each of the appraisers should be careful to prevent the written opinion provided by him/herself from being selected in the plurality of written opinions.

The guarantee charge internet auction is done for the not removed written opinions as an object for bidding on the website of the service provider managing the internet auction by using the information processing device and the internet communication.

The written opinions provided by the plurality of appraisers are individually different from each other and the guarantor tries to obtain the guarantee charge without taking a risk. Therefore, the guarantee charge becomes higher for an unreliable written opinion and the guarantee charge becomes lower for a reliable written opinion.

The check function is added also here by the guarantors. Thus, the reliability of the written opinion appears as the guarantee charge.

The guarantors analyze and check each of the written opinions and send a bid price of the guarantee charge to the website of the service provider managing the internet auction by using the information processing device and the internet communication.

A bidding of the guarantee charge of each of the written opinions is done on the website of the service provider, the guarantor who bid the lowest guarantee charge wins the auction in each of the written opinion, the particular guarantor and the guarantee charge are determined, and the determined guarantor and guarantee charge are connected with each of the written opinions. Thus, various amounts of guarantee charges are applied to all of the written opinions, and the written opinions become the guaranteed written opinion.

As explained above, the written opinions are fairly guaranteed each for the transaction.

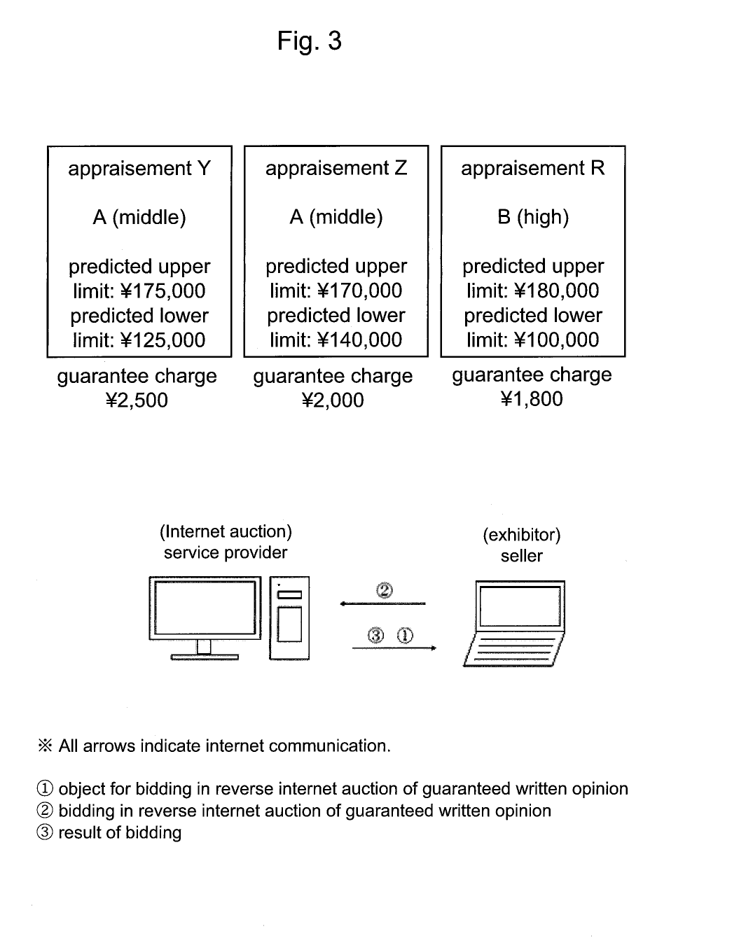

FIG. 3 shows a configuration of a reverse internet auction of a guaranteed written opinion of the present embodiment.

As shown in FIG. 3, the service provider discloses the guaranteed written opinions which are remained as an object for bidding to the seller on the website of the service provider managing the internet auction by using the information processing device and the internet communication, and a reverse internet auction of the guaranteed written opinion is provided on the website of the service provider managing the internet auction by using the information processing device and the internet communication.

The seller is given a right to select a written opinion from the disclosed guaranteed written opinions.

The seller selects a guaranteed written opinion and sends a selection result to the website of the service provider managing the internet auction by using the information processing device and the internet communication.

As for the selected guaranteed written opinion, the service provider pays a commission fee to the appraiser and pays the guarantee charge to the guarantor.

The guaranteed written opinion provided in a fair condition is selected by the seller and the selected guaranteed written opinion is attached to the commodity exhibited by the seller.

The lower limit of the predicted price of the written opinion can be specified as a starting bid price of the internet auction of the commodity.

The fair guaranteed written opinion attached to the commodity of the seller is disclosed with the commodity on the website of the service provider managing the internet auction by using the information processing device and the internet communication.

In order to ensure the fair price formation, the commodity attached with the guaranteed written opinion, which becomes reliable after the guarantee charge internet auction and the reverse internet auction of the guaranteed written opinion, is disclosed on the internet auction of the commodity provided on the website of the service provider managing the internet auction by using the information processing device and the internet communication.

The service provider discloses the images and the guaranteed written opinion of the commodity of the seller exhibited on the internet auction of the commodity on the website of the service provider managing the internet auction by using the information processing device and the internet communication to look for the buyer who wants the transaction.

The guaranteed written opinion is used by the buyer as an information of the commodity and a certificate of the guarantee.

The buyer is protected by the existence of the fair guaranteed written opinion.

With reference to the guaranteed written opinion, the buyer sends a bid price to the website of the service provider managing the internet auction by using the information processing device and the internet communication.

The buyer who bid the highest price wins the auction on the website of the service provider and the internet auction is finished.

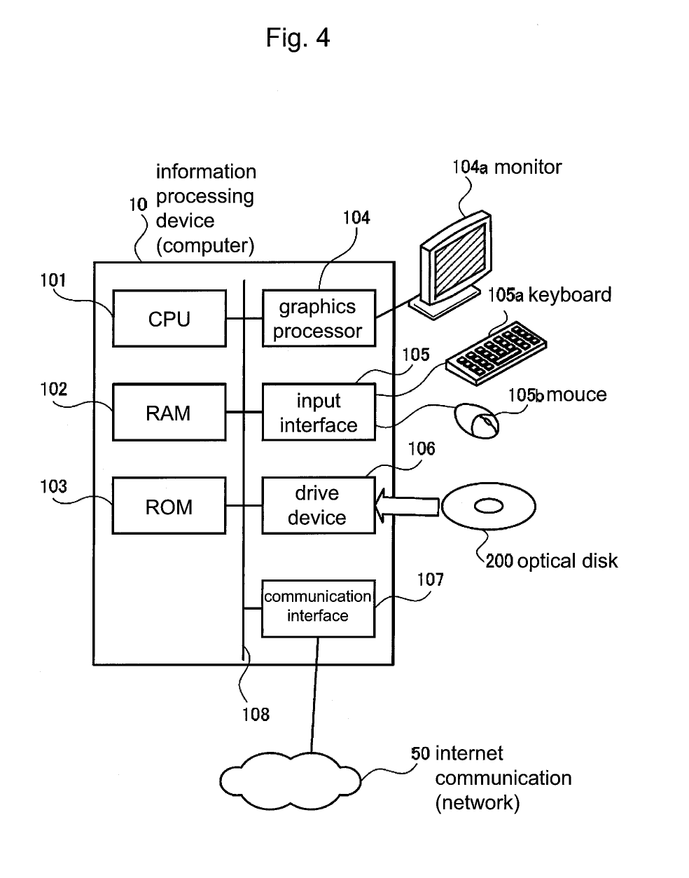

FIG. 4 shows a hardware configuration of the information processing device of the present embodiment.

An information processing device (computer) 10 as a whole is controlled by a CPU 101. A RAM 102 and a plurality of peripheral devices are connected with the CPU 101 via a bus 108.

The RAM 102 is used as a main storage device of the information processing device (computer) 10. The RAM 102 temporarily stores at least a part of a program of an OS (Operating System) and application programs executed by the CPU 101. In addition, the RAM 102 stores various data used for the processing of the CPU 101.

A hard disk drive 103, a graphics processor 104, an input interface 105, a drive device 106 and a communication interface 107 are connected with the bus 108.

The hard disk drive 103 magnetically writes the data in a built-in disk and reads the data from the disk. The hard disk drive 103 is used as a secondary storage device of the information processing device (computer) 10. The hard disk drive 103 stores the program of the OS, the application programs and various data. Note that semiconductor storage devices such as a flash memory can be used as the secondary storage device.

A monitor 104a is connected with the graphics processor 104. The graphics processor 104 displays images on the monitor 104a in accordance with the instruction from the CPU 101. As the monitor 104a, a display device using a CRT (Cathode Ray Tube) and a liquid crystal display device can be used, for example.

A keyboard 105a and a mouse 105b are connected with the input interface 105. The input interface 105 transmits signals received from the keyboard 105a and the mouse 105b to the CPU 101. Note that the mouse 105b is merely an example of a pointing device. Other pointing devices can be also used. As other pointing devices, a touch panel, a tablet, a touch pad and a track ball can be used, for example.

The drive device 106 reads data recorded in a portable recording medium such as an optical disk, which is capable of reading the data by the reflection of light, and a USB (Universal Serial Bus) memory, for example. When the drive device 106 is an optical disk drive, for example, the data recorded in an optical disk 200 is read by using a laser beam or the like. As the optical disk 200, a Blu-ray (registered trademark), a DVD (Digital Versatile Disc), a DVD-RAM (Random Access Memory), a CD-ROM (Compact Disc Read Only Memory), a CD-R (Recordable)/RW (ReWritable) can be used, for example.

The communication interface 107 is connected with an internet communication (network) 50. The communication interface 107 transmits/receives data to/from other computers or communication devices via the internet communication (network).

By using the above described hardware configuration, processing functions of the present embodiment can be achieved. Although the hardware configuration of the information processing device (computer) 10 is shown in FIG. 4, the hardware configuration is same in other computers.

The above embodiment merely shows a principle of the present invention. Furthermore, a person skilled in the art can make various modifications and changes. The present invention is not limited to the exact hardware configuration and application examples described above. Similar hardware configurations and application examples corresponding to the above description are also considered to be included in the present invention.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

While the invention has been particularly shown and described with respect to preferred embodiments thereof, it should be understood by those skilled in the art that the foregoing and other changes in form and detail may be made therein without departing from the sprit and scope of the invention as defined in the appended claims.

What is claimed is:

1. A method for combining, in one transaction, a plurality of internet auctions which are transacted independently for a transaction partner and independently for a transaction object, the method comprising the steps of:
a service provider having a plurality of appraisers provide written opinions for a commodity of a seller exhibited in an internet auction for trading the commodity between the seller and a buyer on a website of the service provider managing the internet auction by using an information processing device and an internet communication;
the service provider providing a guarantee charge internet auction joined by a plurality of guarantors for determining a particular guarantor and a guarantee charge on the website of the service provider managing the internet auction by using the information processing device and the internet communication so that the written opinion is guaranteed when the particular guarantor and the guarantee charge are determined by
disclosing the written opinions of the commodity of the seller to the guarantors,
having each of the guarantors select an overestimated written opinion from the written opinions of the commodity of the seller and vote for the selected written opinion,
selecting arbitrarily a predetermined percentage of the written opinions based on a voting result to remove the selected written opinions from the transaction, and
giving a guarantee to the not removed written opinions; and
the service provider providing a reverse internet auction of the guaranteed written opinion on the website of the service provider managing the internet auction by using the information processing device and the internet communication using a reverse auction method by disclosing the written opinions of the commodity to the seller to give the seller a right of selecting a particular written opinion, wherein
the service provider prepares the written opinions of the commodity of the seller to give the seller options of the written opinions to be selected and the right of selecting the particular written opinion from the written opinions of the commodity of the seller prepared by the service provider, and
the options and the right of selecting the written opinions of the commodity of the seller provided by the service provider to the seller are combined with the internet auction for trading the commodity between the seller and the buyer to achieve a triple auction on the website of the service provider managing the internet auction by using the information processing device and the internet communication.

2. The method for combining a plurality of internet auctions according to claim 1, wherein
the reverse internet auction, which is provided by the service provider by disclosing the written opinions of the commodity of the seller prepared by the appraisers to the seller and having the seller select the particular written opinion from the disclosed written opinions of the commodity of the seller, is combined with the internet auction for trading the commodity between the seller and the buyer on the website of the service provider managing the internet auction by using the information processing device and the internet communication, wherein
the service provider prepares the written opinions of the commodity of the seller to give the seller options of the written opinions to be selected and the right of selecting the particular written opinion from the written opinions of the commodity of the seller prepared by the service provider, and
the options and the right of selecting the written opinions of the commodity of the seller provided by the service provider to the seller are combined with the internet auction for trading the commodity between the seller and a buyer to achieve a triple auction on the website of the service provider managing the internet auction by using the information processing device and the internet communication.

3. The method for combining a plurality of internet auctions according to claim 1, wherein
a guaranteed price of the commodity of the seller is provided on the internet auction for trading the commodity between the seller and the buyer as a predicted price guaranteed by a third party not belonging to neither the seller nor the buyer on the website of the service provider managing the internet auction by using the information processing device and the internet communication.
